(19) United States
(12) Patent Application Publication
(10) Pub. No.: US 2017/0108953 A1
(43) Pub. Date: Apr. 20, 2017

(54) CAPACITIVE STYLUS HAVING ADJUSTABLE PRESSURE SENSING STRUCTURE

(71) Applicant: WALTOP INTERNATIONAL CORPORATION, Hsinchu City (TW)

(72) Inventors: CHUNG-FUU MAO, Hsinchu City (TW); YI-CHIH CHANG, Hsinchu City (TW)

(21) Appl. No.: 14/942,654

(22) Filed: Nov. 16, 2015

(30) Foreign Application Priority Data
Oct. 16, 2015 (TW) 104133944

(51) Int. Cl. G06F 3/0354

(52) U.S. Cl. CPC G06F 3/03545

(57) ABSTRACT

The capacitive stylus includes a pen tube, an upper skeleton structure, a lower skeleton structure, a pen cover, a refill, a refill holder, a trigger element, a spring, a control circuit board, a pressure sensing element and an adjusting element. The pen cover is connected with the pen tube by the upper skeleton structure and the lower skeleton structure. The trigger element is inserted in another end of the refill holder. The pressure sensing element is electrically connected with the control circuit board and disposed in accordance with the trigger element. When the refill and the refill holder press the spring so that the trigger element contacts the pressure sensing element, the pressure sensing element detects the pressure force against the refill. The adjusting element is configured to adjust the gap between the pressure sensing element and the trigger element.

### CLAIM OF PRIORITY

The present application claims priority from Taiwan Application No.104133944, filed on Oct. 16, 2015 and entitled “CAPACITIVE STYLUS HAVING ADJUSTABLE PRESSURESENSING STRUCTURE”, the contents of which are expressly incorporated herein by reference in their entirety.

### BACKGROUND OF THE INVENTION

1. Field of the Invention

The present invention generally relates to a capacitive stylus, and more particularly to a capacitive stylus having an adjustable pressure sensing structure.

2. Description of Related Art

Capacitive touch input technology has been widely applied in touch panel. Capacitive touch input technology has advantages of allowing the use of variety of touch sources such as an user's finger(s) for input operation and multi-touch gestures for various operations and functions. Various applications can be assigned corresponding to multi-touch gestures. However, capacitive touch input technology lacks input functions with a stylus. Performing touch control input by a stylus has advantages of convenient for writing, tip pressure level function, and certain sensing height.

Thus the present invention provides a capacitive stylus having an adjustable pressure sensing structure, which may not only allow user to perform touch control functions with the stylus on a capacitive touch control panel, but also allow user to adjust the sensitivity of detecting the pressure force against the stylus and the feedback effect thereof, in accordance with user's habit and need.

### SUMMARY OF THE INVENTION

In view of the foregoing, it is an object of embodiments of the present invention to provide a capacitive stylus, which may allow user to adjust the sensitivity of detecting the pressure force against the stylus and the feedback effect thereof, in accordance with user's habit and need.

According to the object, one embodiment of the present invention provides a capacitive stylus. The capacitive stylus includes a pen tube, a button, an upper skeleton structure, a lower skeleton structure, a pen cover, a refill, a refill holder, a trigger element, a spring, a control circuit board, a pressure sensing element and an adjusting element. The pen cover is connected with the pen tube by the upper skeleton structure and the lower skeleton structure. The refill holder is disposed between the upper skeleton structure and the lower skeleton structure. The refill is inserted in one end of the refill holder. The trigger element is inserted in another end of the refill holder. The spring surrounds another end of the refill holder. One end of the spring is electrically connected with the control circuit board. The pressure sensing element is soldered on one side of a flexible printed circuit board, in order to be electrically connected with the control circuit board, and the pressure sensing element is disposed in accordance with the trigger element. A gap exists between the pressure sensing element and the trigger element. When the refill and the refill holder press the spring so that the trigger element contacts the pressure sensing element, the pressure sensing element detects the pressure force against the refill. The adjusting element is inserted by the refill and the adjusting element also inserts through the pen cover. One end of the adjusting element is disposed against one end of the refill holder, and another end of the adjusting element is exposed from the pen cover, which is configured to adjust the gap between the pressure sensing element and the trigger element.

### BRIEF DESCRIPTION OF THE DRAWINGS

FIG. 1 shows a capacitive stylus having an adjustable pressure sensing structure, according to one embodiment of the invention.

FIG. 2 shows a partial cross-sectional view of the capacitive stylus in FIG. 1, according to one embodiment of the invention.

FIG. 3 shows an exploded view of the capacitive stylus in FIG. 1, according to one embodiment of the invention.

FIG. 4 shows partial elements of the capacitive stylus in FIG. 1, according to one embodiment of the invention.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the scale of each component may not expressly exactly.

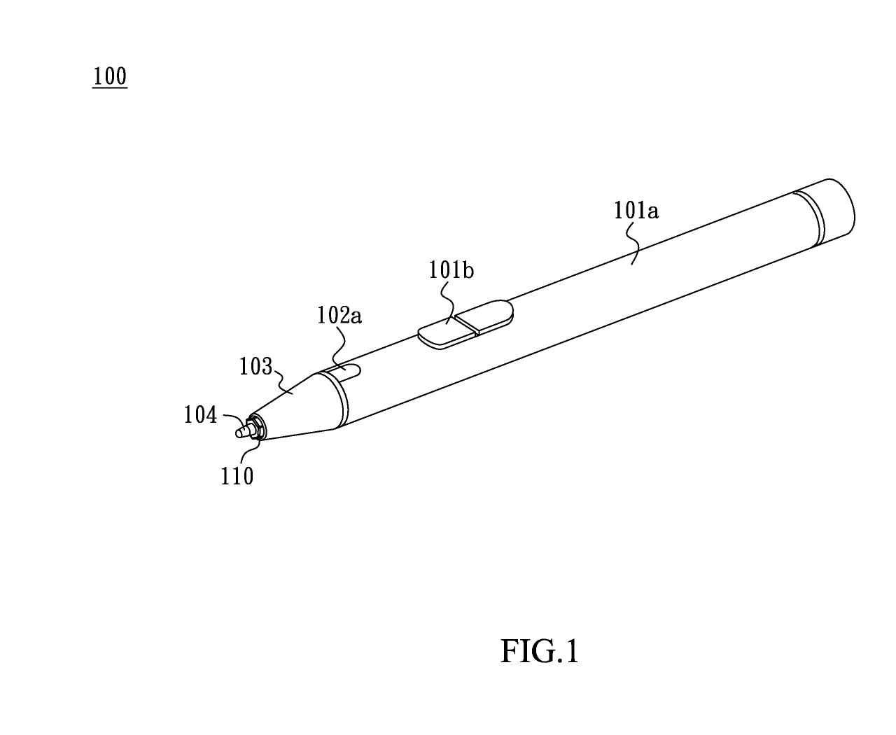

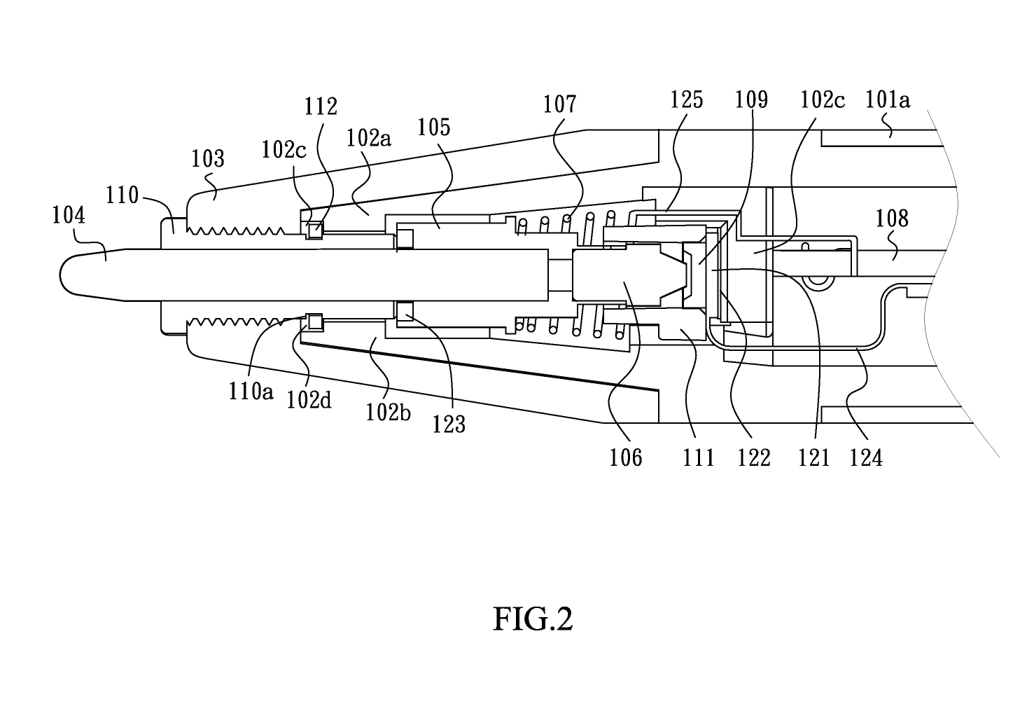

Referring to FIG. 1 and FIG. 2, FIG. 1 shows a capacitive stylus having an adjustable pressure sensing structure, according to one embodiment of the invention, and FIG. 2 shows a partial cross-sectional view of the capacitive stylus in FIG. 1. As shown in figures, the capacitive stylus 100, having an adjustable pressure sensing structure, includes a pen tube 101a, a button 101b, an upper skeleton structure 102a, a lower skeleton structure 102b, a pen cover 103, a refill 104, a refill holder 105, a trigger element 106, a spring 107, a control circuit board 108, a pressure sensing element 109 and an adjusting element 110. The pen cover 103 is connected with the pen tube 101a by the upper skeleton structure 102a and the lower skeleton structure 102b. The refill holder 105 is disposed between the upper skeleton structure 102a and the lower skeleton structure 102b. The refill 104 is inserted in one end of the refill holder 105. The trigger element 106 is inserted in another end of the refill holder 105. The spring 107 surrounds another end of the refill holder 105. One end of the spring 107 is electrically connected with the control circuit board 108. The pressure sensing element 109 is soldered on one side of a flexible printed circuit board (FPC) 121, in order to be electrically connected with the control circuit board 108, and the pressure sensing element 109 is disposed in accordance with the trigger element 106. A gap exists between the pressure sensing element 109 and the trigger element 106. When the refill 104 and the refill holder 105 press the spring 107 so that the trigger element 106 contacts the pressure sensing element 109, the pressure sensing element 109 detects the pressure force against the refill 104. The adjusting element 110 is inserted by the refill 104 and the adjusting element 110 also inserts through the pen cover 103. One end of the adjusting element 110 is disposed against one end of the refill holder 105, and another end of the adjusting element 110 is exposed from the pen cover 103, which is configured to adjust the gap between the pressure sensing element 109 and the trigger element 106.

Furthermore, in this embodiment, the material of the pen tube 101a, the button 101b, the upper skeleton structure 102a, the lower skeleton structure 102b, the pen cover 103 and the adjusting element 110 includes non-conductive material, such as acrylonitrile butadiene styrene and polycarbonate. The material of the refill 104, the refill holder 105 and the spring 107 may have conductive material. For instance, the material of the refill 104 and the refill holder 105 may include aluminum, and the material of the spring 107 may include steel. However, the present invention is not limited thereto, other suitable conductive materials may be applied.

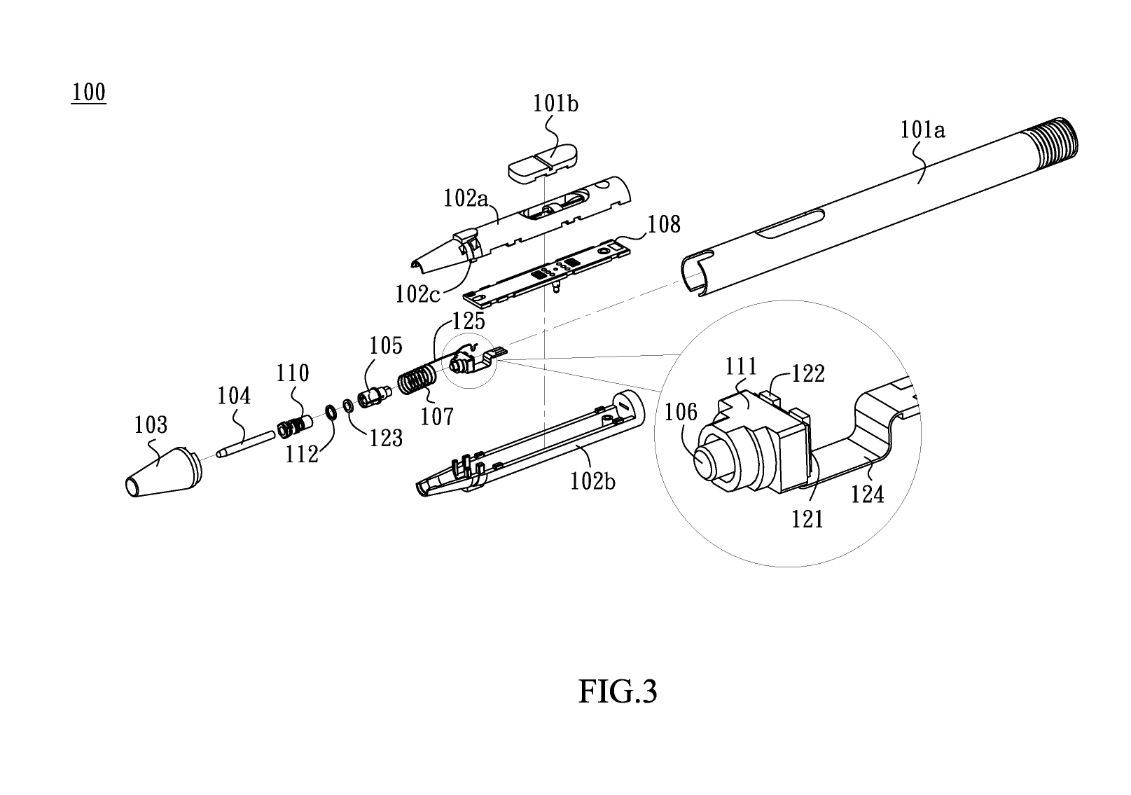

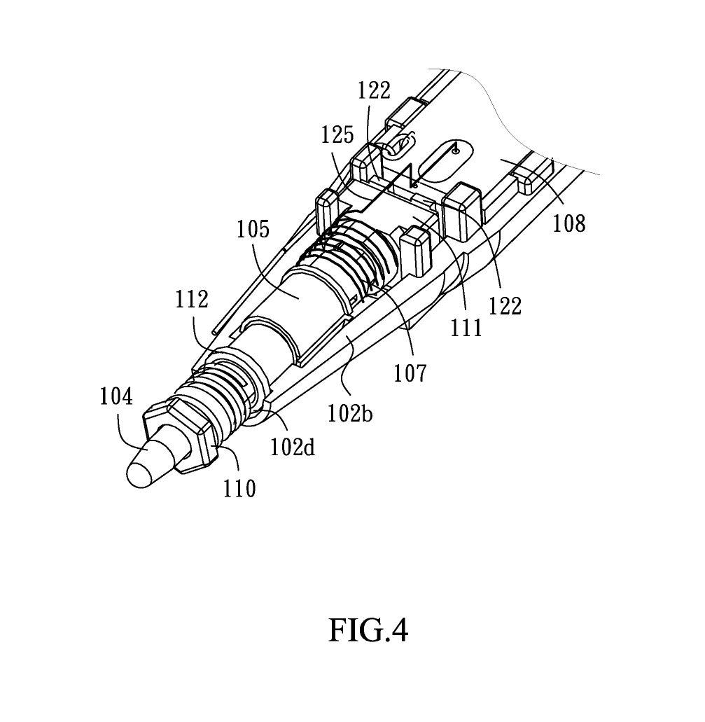

Referring to FIG. 2, FIG. 3 and FIG. 4, wherein FIG. 3 shows an exploded view of the capacitive stylus in FIG. 1, and FIG. 4 shows partial elements of the capacitive stylus in FIG. 1. As shown in figures, the adjusting element 110 may be threadedly connected in the pen cover 103, which is configured for the user to rotate another end of the adjusting element 110 so as to adjust a width of the gap. That is to say, the user can rotate one end of the adjusting element 110, which is exposed from the pen cover 103, to change a relative position of the refill holder 105 according to the actual writing or drawing needs. Thus, the width of the gap between the trigger element 106 and the pressure sensing element 109 can be well adjusted, so that when the capacitive stylus 100 contacts the touch panel, the sensitivity of detecting the pressure force against the stylus and the feedback effect thereof may be adjusted accordingly.

Moreover, in this embodiment, the upper skeleton structure 102a and the lower skeleton structure 102b may be connected with each other, so as to form a cavity to cover the refill 104, the refill holder 105, the spring 107, the trigger element 106 and the pressure sensing element 109. The pen cover 103 covers one end of the upper skeleton structure 102a and the lower skeleton structure 102b, and the pen tube 101a covers another end of the upper skeleton structure 102a and the lower skeleton structure 102b. Further, the adjusting element 110 is inserted through the pen cover 103 and also inserted between the upper skeleton structure 102a and the lower skeleton structure 102b. The top part of one end of the adjusting element 110 is exposed from the pen cover 103. In one embodiment, the adjusting element 110 may have a screw appearance, so that the user may rotate the screw cap of the adjusting element 110, which is exposed from the pen cover 103, in order to adjust the width of the gap between the trigger element 106 and the pressure sensing element 109.

In addition, in one embodiment, the refill holder further includes a silencer pad 123, disposed on one end of the refill holder 105 and disposed against the adjusting element 110, so that the noise generated from rotating the adjusting element 110 may be reduced. The silencer pad 123 may include flexible cushioning material, such as rubber.

Referring to FIG. 2, FIG. 3 and FIG. 4, the capacitive stylus 100 may include a limiting element 112. The limiting element 112 is disposed on the top part of the upper skeleton structure 102a and the lower skeleton structure 102b, and configured to be hooked in a notch 110a of the adjusting element 110. The thickness of the limiting element 112 is less than the width of the notch 110a. Thus, as the limiting element 112 is hooked in the notch 110a of the adjusting element 110, an adjustable distance for the adjusting element 110 rotating in the capacitive stylus 100 will be limited to be a specific range, so as to efficiently prevent the trigger element 106 and the pressure sensing element 109 from being connected with each other and generating a false touching signal, during the operation of adjusting process.

In this embodiment, the top part of upper skeleton structure 102a and the lower skeleton structure 102b may respectively have an upper slot 102c and a lower slot 102d, and the limiting element 112 is disposed in the upper slot 102c and the lower slot 102d. In another embodiment, the limiting element 112 may have a ring-shaped appearance or a C-shaped appearance, and thus the limiting element 112 can be simultaneously disposed in both of the upper slot 102c and the lower slot 102d, so that the limiting element 112 not only can limit the range of the adjustable displacement of the adjusting element 110, but also can effectively fix the upper skeleton structure 102a and the lower skeleton structure 102b.

In FIG. 2, FIG. 3 and FIG. 4, the capacitive stylus 100 may further include a fixing holder 111. The fixing holder 111 is inserted by the pressure sensing element 109, in order to fix the pressure sensing element 109 between the upper skeleton structure 102a and the lower skeleton structure 102b. Furthermore, in one embodiment, the upper skeleton structure 102a can have a rib plate 102c. The rib plate 102c is disposed between the flexible printed circuit board 121 and the control circuit board 108. However, in this embodiment, the capacitive stylus 100 can include a protecting pad 122. The protecting pad is disposed on a side of the rib plate 102c, facing another side of the flexible printed circuit board 121, in order to provide the pressure sensing element 109 with an anti-drop and anti-shock buffering protection mechanism. The protecting pad 122 may include flexible cushioning material, such as rubber.

Moreover, in this embodiment, the control circuit board 108 is electrically connected with the flexible printed circuit board 121 and the spring 107 by the first connecting part 124 and the second connecting part 125. Thus, when the user uses the capacitive stylus 100 to write or draw on a touch panel, the refill 104, the refill holder 105 and the trigger element 106 apply pressure on the pressure sensing element 109 to change voltage or current, so that the pressure sensing element 109 may sense tip pressure of the capacitive pointer 100 upon the touch panel to generate a sensing signal, and the sensing signal is transmitted to the control circuit board 108 by the first connecting part 124. Then, the control circuit board 108 will perform an operation process to generate a feedback signal according to the received sensing signal, and the feedback signal will be sequentially transmitted to the spring 107, the refill holder 105 and the refill 104 by the second connecting part 125. Afterwards, the refill 104 will transmit the feedback signal to the touch panel for performing functions such as drawing or writing line. At the same time, the spring 107 is also used to make the refill 104, the refill holder 105 and the trigger element 106 back to the original position.

In one embodiment, the stylus 100 can include a battery. The battery is configured to provide the power to the control circuit board 108 for the operation, and the battery may also be disposed in the pen tube 101a.

The capacitive stylus having an adjustable pressure sensing structure, according to one embodiment of the invention, not only allows user to perform touch control functions with the stylus on a capacitive touch control panel, but also allows user to adjust the sensitivity of detecting the pressure force against the stylus and the feedback effect thereof, in accordance with user's habit and need.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus having an adjustable pressure sensing structure, comprising:
a pen tube;
an upper skeleton structure;
a lower skeleton structure;
a pen cover, connected with the pen tube by the upper skeleton structure and the lower skeleton structure;
a refill;
a refill holder, disposed between the upper skeleton structure and the lower skeleton structure, wherein the refill is inserted in one end of the refill holder;
a trigger element, inserted in another end of the refill holder;
a spring, surrounding another end of the refill holder;
a control circuit board, wherein one end of the spring is electrically connected with the control circuit board;
a pressure sensing element, soldered on one side of a flexible printed circuit board, in order to be electrically connected with the control circuit board, and disposed in accordance with the trigger element, wherein a gap exists between the pressure sensing element and the trigger element, when the refill and the refill holder press the spring so that the trigger element contacts the pressure sensing element, the pressure sensing element detects the pressure force against the refill; and
an adjusting element, inserted by the refill and inserting through the pen cover, wherein one end of the adjusting element is disposed against the refill holder, and another end of the adjusting element is exposed from the pen cover, which is configured to adjust the gap between the pressure sensing element and the trigger element.

2. The capacitive stylus of claim 1, wherein the adjusting element is threadedly connected in the pen cover, which is configured to adjust a width of the gap by rotating another end of the adjusting element.

3. The capacitive stylus of claim 1, wherein the upper skeleton structure and the lower skeleton structure cover the refill, the refill holder, the spring, the trigger element and the pressure sensing element

4. The capacitive stylus of claim 3, wherein the pen cover covers one end of the upper skeleton structure and the lower skeleton structure, and the pen tube covers another end of the upper skeleton structure and the lower skeleton structure.

5. The capacitive stylus of claim 4, wherein the adjusting element inserted in the pen cover and inserted between the upper skeleton structure and the lower skeleton structure, and another end of the adjusting element is exposed from the pen cover.

6. The capacitive stylus of claim 1, wherein the adjusting element has a screw appearance.

7. The capacitive stylus of claim 1, further comprising a fixing holder, inserted by the pressure sensing element, so as to fix the pressure sensing element between the upper skeleton structure and the lower skeleton structure.

8. The capacitive stylus of claim 1, further comprising a limiting element, disposed on a top part of the upper skeleton structure and the lower skeleton structure, and configured to be hooked in a notch of the adjusting element.

9. The capacitive stylus of claim 8, wherein a width of the limiting element is less than a width of the notch.

10. The capacitive stylus of claim 8, wherein the top part of the upper skeleton structure and the lower skeleton structure have an upper slot and a lower slot respectively, and the limiting element is disposed in the upper slot and the lower slot.

11. The capacitive stylus of claim 8, wherein the limiting element has a ring-shaped appearance or a C-shaped appearance.

12. The capacitive stylus of claim 1, wherein the refill holder further comprises a silencer pad, disposed on one end of the refill holder and configured to be against the adjusting element.

13. The capacitive stylus of claim 1, wherein the upper skeleton structure includes a rib plate, disposed between the flexible printed circuit board and the control circuit board .

14. The capacitive stylus of claim 13, further comprising a protecting pad, disposed on one side of the rib plate and facing another side of the flexible printed circuit board.

15. The capacitive stylus of claim 1, wherein the material of the pen tube, the button, the upper skeleton structure, the lower skeleton structure, the pen cover and the adjusting element comprises acrylonitrile butadiene styrene and polycarbonate.

16. The capacitive stylus of claim 1, wherein the material of the refill and the refill holder comprises aluminum.

17. The capacitive stylus of claim 1, wherein the material of the spring comprises steel.
